(19) United States
(12) Patent Application Publication
(10) Pub. No.: US 2014/0042826 A1
(43) Pub. Date: Feb. 13, 2014

(54) POWER ADAPTOR SYSTEM

(71) Applicant: QUANTA COMPUTER INC., Tao Yuan Shien (TW)

(72) Inventors: Tai-Hsin CHU, Taipei City (TW); Wei-Ting LU, Tainan City (TW); Yu-An HUANG, Taoyuan City (TW); Yu-Hui CHEN, Tao Yuan Shien (TW); Tsung-Lin CHAN, Taichung City (TW); Hsin-Wei CHEN, Bade City (TW); Bo-Wun WANG, Taichung City (TW)

(73) Assignee: QUANTA COMPUTER INC., Tao Yuan Shien (TW)

(21) Appl. No.: 13/661,142

(22) Filed: Oct. 26, 2012

(30) Foreign Application Priority Data
Aug. 9, 2012 (TW) 101128843

(51) Int. Cl. H01H 47/00

(52) U.S. Cl. 307/115

(57) ABSTRACT

A power adaptor system including a system side and a power adaptor side is provided. The system side includes a first connector, a system circuit, a storage capacitor, and a first microcontroller. The storage capacitor is charged by an initial voltage received via the first connector. The first microcontroller outputs a system side setting after the storage capacitor is completely charged. The power adaptor side includes a second connector, a power adaptor circuit, and a second microcontroller. The second connector is for electrically connecting to the first connector. The second microcontroller receives the system side setting via the second connector, and controls the power adaptor circuit to output an operating voltage required by the system circuit according to the system side setting.

This application claims the benefit of Taiwan application Serial No. 101128843, filed Aug. 9, 2012, the subject matter of which is incorporated herein by reference.

### BACKGROUND OF THE INVENTION

1. Field of the Invention

The invention relates in general to an adaptor system, and more particularly to a power adaptor system.

2. Description of the Related Art

As the technology continuously progresses, electronic devices with diversified functions are now market-available. In addition to fulfilling needs of individuals, these electronic devices profoundly prevail in the modern lifestyle to offer indispensible conveniences. To adapt to different circuit designs, operating voltages of the electronic devices may vary. Therefore, it is essential that manufacturers enclose a corresponding power adaptor for a specific electronic device to ensure that an appropriate operating voltage is provided to the electronic device.

For example, a 5V power adaptor is utilized for an electronic device that needs a 5V operating voltage, a 12V power adaptor is utilized for an electronic that needs a 12V operating voltage, and a 19V power adaptor is utilized for an electronic device that needs a 19V operating voltage. Consequently, the number of power adaptors grows to lead to an environmental-unfriendly issue.

### SUMMARY OF THE INVENTION

The invention is directed to a power adaptor system.

A power adaptor system is provided by the present disclosure. The power adaptor system includes a system side and a power adaptor side. The system side includes a first connector, a system circuit, a storage capacitor, and a first microcontroller. The storage capacitor is charged by an initial voltage received via the first connector. The first microcontroller outputs a system side setting after the storage capacitor is completely charged. The power adaptor system includes a second connector, a power adaptor circuit, and a second microcontroller. The second connector is for electrically connecting to the first connector. The second microcontroller receives the system side setting via the second connector, and controls the power adaptor circuit to output an operating voltage required by the system circuit according to the system side setting.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a power adaptor system according to a first embodiment.

FIG. 2 is a flowchart of a power adaptor method according to the first embodiment.

FIG. 3 is a schematic diagram of a power adaptor system according to a second embodiment.

FIG. 4 is a schematic diagram of a power adaptor system according to a third embodiment.

### DETAILED DESCRIPTION OF THE INVENTION

### First Embodiment

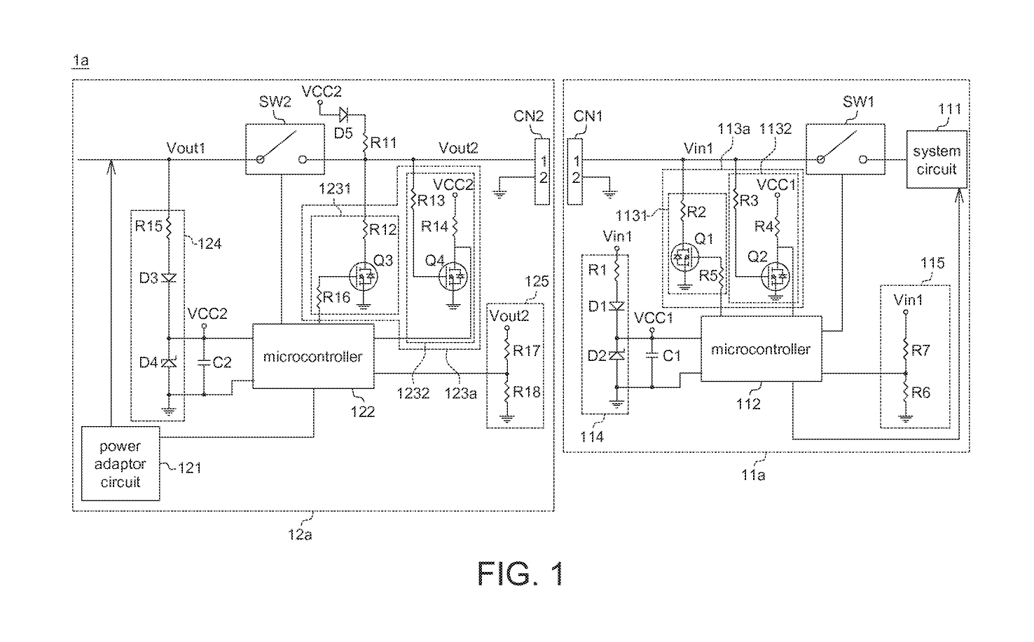

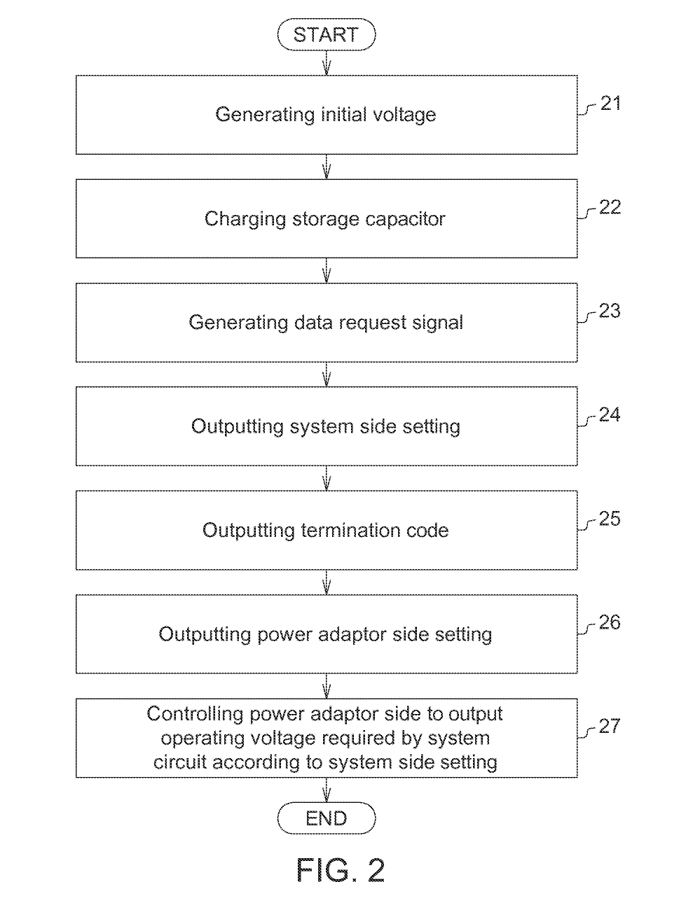

FIG. 1 shows a schematic diagram of a power adaptor system according to a first embodiment; FIG. 2 shows a flowchart of a power adaptor method according to the first embodiment. Referring to FIG. 1, a power adaptor system 1a includes a system side 11a and a power adaptor side 12a. For example, the system side 11a and the power adaptor side 12a are respectively a computer system and a power adaptor. The system side 11a includes a connector CN1, a switch SW1, a system circuit 111, a microcontroller 112, an interface circuit 113a, a power transmission circuit 114, a voltage divider 115, and a storage capacitor C1. The power adaptor side 12a includes a connector C2, a switch SW2, a power adaptor circuit 121, a microcontroller 122, an interface circuit 123a, a power transmission circuit 124, a voltage divider 125, and a regulator capacitor C2. The voltage divider 115 is coupled to the microcontroller 112; the voltage divider 125 is coupled to the microcontroller 122. The voltage divider 115 includes a resistor R6 and a resistor R7; the voltage divider 125 includes a resistor R17 and a resistor R18. The switch SW1 is controlled by the microcontroller 112 to selectively electrically connect the connector CN1 to the system circuit 111; the switch SW2 is controlled by the microcontroller 122 to selectively electrically connect the connector CN2 to the system circuit 121.

The microcontroller 112 communicates with the microcontroller 122 via the interface circuit 113a and the interface circuit 123a. The interface circuit 113a includes a data transmitting circuit 1131 and a data receiving circuit 1132; the interface circuit 123a includes a data transmitting circuit 1231 and a data receiving circuit 1232. The interface circuit 123a is coupled to a diode D5 via a resistor R11. The microcontroller 112 communicates with the microcontroller 122 via the data transmitting circuit 1131 and the data receiving circuit 1232; the microcontroller 122 communicates with the microcontroller 112 via the data transmitting circuit 1231 and the data receiving circuit 1132. The data transmitting circuit 1131 includes a resistor R2, a resistor R5, and a transistor Q1; the data receiving circuit 1132 includes a resistor R3, a resistor R4 and a transistor Q2. The data transmitting circuit 1231 includes a resistor R12, a resistor R16 and a transistor Q3; the data transmitting circuit 1232 includes a resistor R13, a resistor R14 and a transistor Q4.

The power transmission circuit 114, coupled to the microcontroller 112 and the storage capacitor C1, includes a resistor R1, a diode D1 and a Zener diode D2. The Zener diode C2 is coupled to the capacitor C1 in parallel to supply the microcontroller 112 with a required voltage VCC1. Similarly, the power transmission circuit 124, coupled to the microcontroller 122, includes a resistor R15, a diode D3 and a Zener diode D4. The Zener diode D4 is coupled to the regulator capacitor C2 in parallel to supply the microcontroller 122 with a required voltage VCC2. Further, the power transmission circuit 114 and the power transmission circuit 124 may also be implemented by switchable power supplies.

The power adaptor method, applicable to the power adaptor system 1, includes the following steps. In Step 21, an initial voltage is automatically generated. For example, the initial voltage is 5V. In Step 22, the storage capacitor C1 is charged by the initial voltage received via the connector C1 and the power transmission circuit 114. When the storage capacitor C1 is completely charged, the microcontroller 112 turns off the switch SW1 and the microcontroller 122 turns on the switch S2.

In Step 23, after the storage capacitor C1 is completely charged, the microcontroller 122 generates a data request signal. For example, after the microcontroller 122 turns off the switch SW2, a pulse signal is formed by enabling the transistor Q3 to inform the microcontroller 112 to start transmitting a system side setting. In Step 24, after receiving the data request signal, the microcontroller 112 outputs the system side setting to the microcontroller 122. The microcontroller 122 receives the system setting via the connector CN2 and the data receiving circuit 1232 of the interface circuit 123a. For example, the system setting is a voltage or current required by the system circuit 111. For example, the system side setting is 001 when the voltage required by the system circuit 111 is 5V, 010 when the voltage required by the system circuit 111 is 12V, and 011 when the voltage required by the system circuit 111 is 19V.

In Step 25, after sending the system side setting, the microcontroller 112 outputs a termination code to the microcontroller 122. In Step 26, the microcontroller 112 receives a power adaptor setting outputted by the microcontroller 122. For example, the power adaptor side setting is an output voltage, a maximum current or a power outputted by the power adaptor circuit 121. The microcontroller 112 is allowed to subsequently set the system circuit 111 according to the power adaptor side setting. For example, assume that the system circuit 111 requires a power consumption of 150 W whereas the power provided by the power adaptor circuit 121 is 100 W. The microcontroller 112 controls a central processing unit in the system circuit 111 to perform down-conversion according to the power adaptor side setting to reduce the power consumption.

In Step 27, the microcontroller 122 controls the power adaptor circuit 121 to output an operating voltage Vout1 required by the system circuit 111 according to the system side setting. While outputting the operating voltage Vout1 required by the system circuit 111, the microcontroller 122 turns on the switch SW2 and the microcontroller 112 then turns on the switch SW1. Thus, regardless of the value of the operating voltage required by the system circuit 111, the power adaptor circuit 121 is enabled to output the corresponding operating voltage Vout1 via the communication between the system side 11a and the power adaptor side 12a.

In the subsequent powering process, the power adaptor circuit 121 detects a load power consumption status and informs the microcontroller 122 of an associated detection result. When the load power consumption status indicates a light load status, the microcontroller 122 turns off the switch SW2. The microcontroller 122 further determines whether the connector CN1 is electrically connected to the connector CN2 according to a drop level in a voltage Vout2 between the connector CN2 and the switch SW2. An electrical disconnection between the connector CN1 and the connector CN2 indicates that the system side 11a is disconnected from the power adaptor side 12a.

If the power adaptor side 12a is directly connected to another system side having a different operating voltage, malfunction may be resulted. Therefore, when the connector CN1 is not electrically connected to the connector CN2, the microcontroller 122 controls the power adaptor circuit 121 to set the operating voltage Vout1 to equal to the initial voltage, and the power adaptor circuit 121 is again controlled using the foregoing power adaptor method to output the operating voltage Vout1 required by the new system side.

Further, the microcontroller 112 also detects a drop level in the voltage Vin1 between the connector CN1 and the switch SW1. The microcontroller 112 determines whether the connector CN1 is electrically connected to the connector CN2 according to the drop level in the voltage Vin1. As the voltage Vin1 between the connector CN1 and the switch SW1 drops to a predetermined value, the microcontroller 112 generates a normal connection signal to the microcontroller 122. For example, the normal connection signal is generated by the transistor Q1 conducted by the microcontroller 112.

### Second Embodiment

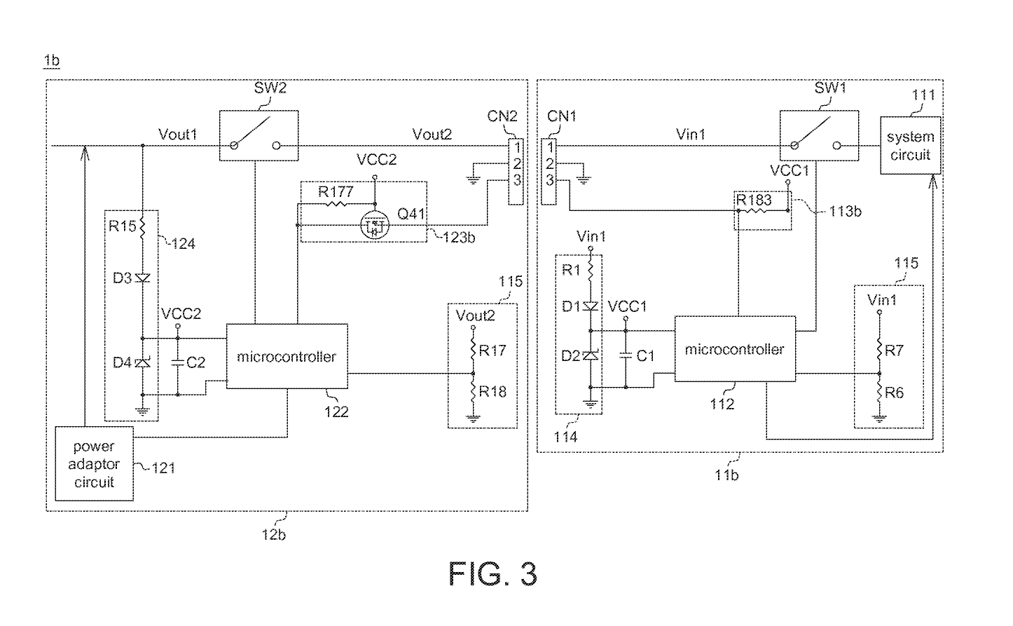

FIG. 3 shows a schematic diagram of a power adaptor system according to a second embodiment. A main difference between the second embodiment and the first embodiment is that, in the second embodiment, a voltage and data between a system side 11b and a power adaptor side 12b are independently transmitted. An interface circuit 113b of the system side includes a resistor R183; an interface circuit 123b of the power adaptor side 12b includes a transistor Q41 and a resistor R177. Since the connector CN1 and the connector CN2 respectively includes three pins, the signal communication between the system side 11b and the power adaptor side 12b is even more independent. Thus, circuit designs of the interface circuit 113b and the interface circuit 123b are further simplified to maintain an uncomplicated communication between the microcontroller 112 and the microcontroller 122.

### Third Embodiment

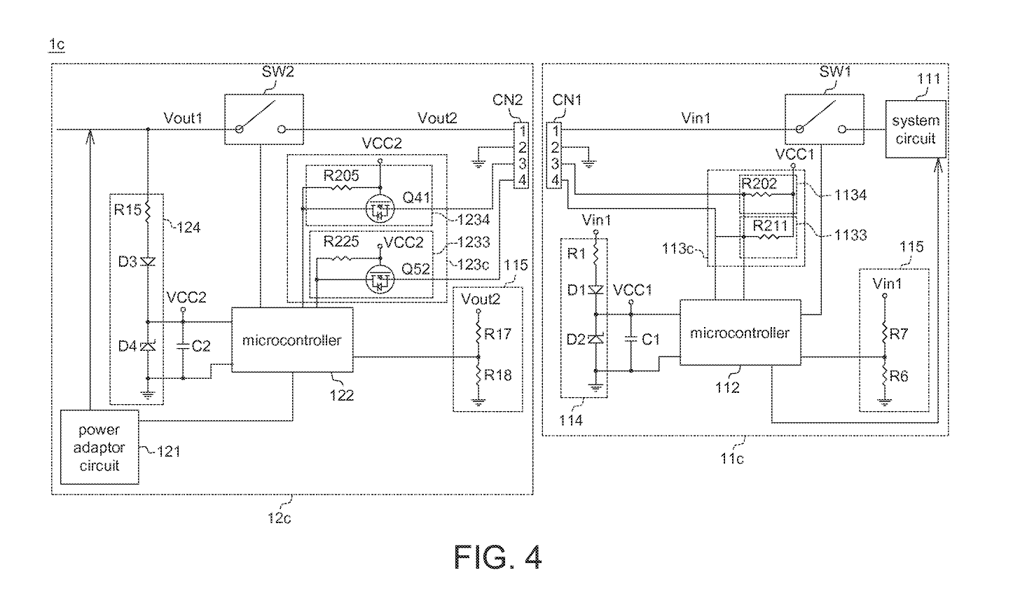

FIG. 4 shows a schematic diagram of a power adaptor system according to a third embodiment. A main difference between the third embodiment and the second embodiment is that, in the third embodiment, the connector CN1 and the connector CN2 respectively include four pins. Thus, data and clock communications between a system side 11c and a power adaptor side 12c can be performed. An interface circuit 113c includes a data communication circuit 1133 and a clock communication circuit 1134; an interface circuit 123c includes a data communication circuit 1233 and a clock communication circuit 1234. The microcontroller 112 communicates with the microcontroller 122 via the data communication circuit 1133 and the data communication circuit 1233; the microcontroller 122 communicates with the microcontroller 112 via the clock communication circuit 1234 and the clock communication circuit 1134.

The data communication circuit 1133 includes a resistor R211; the clock communication circuit 1134 includes a resistor R202. The data communication circuit 1233 includes a transistor Q52 and a resistor R225; the clock communication circuit 1234 includes a transistor Q41 and a resistor R205.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power adaptor system, comprising:
a system side, comprising:
a first connector;
a system circuit;
a storage capacitor, charged by an initial voltage received via the first connector;
a first microcontroller, outputting a system side setting after the storage capacitor is completely charged; and
a power adaptor side, comprising:
a second connector, for electrically connecting the first connector;
a power adaptor circuit; and
a second microcontroller, receiving the system side setting via the second connector, and controlling the power adaptor circuit to output an operating voltage required by the system circuit according to the system side setting.

2. The power adaptor system according to claim 1, wherein the first microcontroller further receives a power adaptor side setting outputted by the second microcontroller and sets the system circuit according to the power adaptor side setting.

3. The power adaptor system according to claim 1, wherein the second microcontroller further generates a data request signal, and the first microcontroller outputs the system side setting to the second microcontroller after receiving the data request signal.

4. The power adaptor system according to claim 1, wherein the first microcontroller outputs a termination code to the second microcontroller after transmitting the system side setting.

5. The power adaptor system according to claim 1, wherein the system side further comprises a first switch, and the first switch is controlled by the first microcontroller to selectively electrically connect the first connector to the system circuit; and the power adaptor side further comprises a second switch, and the second switch is controlled by the second microcontroller to selectively electrically connect the second connector to the power adaptor circuit.

6. The power adaptor system according to claim 5, wherein while the storage capacitor is being charged, the first microcontroller turns on the first switch and the second microcontroller turns on the second switch.

7. The power adaptor system according to claim 5, wherein when the storage capacitor is completely charged, the first microcontroller turns off the first switch and the second microcontroller turns off the second switch.

8. The power adaptor system according to claim 5, wherein when outputting the operating voltage required by the system circuit, the first microcontroller turns on the first switch after the second microcontroller turns on the second switch.

9. The power adaptor system according to claim 5, wherein when a load power consumption status is a light load status, the second microcontroller turns off the second switch.

10. The power adaptor system according to claim 9, wherein the second microcontroller determines whether the first connector is electrically connected to the second connector according to a drop level in a voltage between the second connector and the second switch, and controls the power adaptor circuit to set the operating voltage to equal to the initial voltage when the first connector is not electrically connected to the second connector.

11. The power adaptor system according to claim 5, wherein the first microcontroller determines whether first connector is electrically connected to the second connector according to a drop level in a voltage between the first connector and the first switch.

12. The power adaptor system according to claim 11, wherein when the voltage between the first connector and the first switch drops to a predetermined value, the first microcontroller generates a normal connection signal to the second microcontroller.

13. The power adaptor system according to claim 1, wherein the system side further comprises a first interface circuit, the power adaptor side further comprises a second interface circuit, and the first microcontroller communicates with the second microcontroller via the first interface circuit and the second interface circuit.

14. The power adaptor system according to claim 13, wherein the first interface circuit comprises a first data transmitting circuit and a first data receiving circuit, the second interface circuit comprises a second data transmitting circuit and a second data receiving circuit, the first microcontroller communicates with the second microcontroller via the first data transmitting circuit and the second data receiving circuit, and the second microcontroller communicates with the first microcontroller via the second data transmitting circuit and the first data receiving circuit.

15. The power adaptor system according to claim 13, wherein the first interface circuit comprises a first data communication circuit and a first clock communication circuit, the second interface circuit comprises a second data communication circuit and a second clock communication circuit, the first microcontroller communicates with the second microcontroller via the first data communication circuit and the second data communication circuit, and the second microcontroller communicates with the first microcontroller via the second clock communication circuit and the first clock communication circuit.

16. The power adaptor system according to claim 1, wherein the system side further comprises a first power transmission circuit coupled to the first microcontroller and the storage capacitor, and the power adaptor side further comprises a second power transmission circuit coupled to the second microcontroller.

17. The power adaptor system according to claim 16, wherein the first power transmission circuit and the second power transmission circuit are respectively a switchable power supply.
